(19) United States
(12) Patent Application Publication
(10) Pub. No.: US 2026/0231876 A1
(43) Pub. Date: Aug. 13, 2026

(54) Method of Manufacturing a Biodegradable Polymeric Nutrient Releasing Material, and Articles and Containers Made Therefrom

(71) Applicant: United Arab Emirates University, Al Ain (AE)

(72) Inventors: Dali Vilma Francis, Al Ain (AE); Zienab Fawzy Riad Ahmed, Al Ain (AE)

(21) Appl. No.: 19/051,703

(22) Filed: Feb. 12, 2025

(51) Int. Cl. A01G 24/35; A01G 31/02

(52) U.S. Cl. CPC A01G 24/35; A01G 31/02

(57) ABSTRACT

A nutrient-releasing tray (10) for plant growth, comprising a master tray (12) with a water container (14) and a cover element (16) featuring spaced receptacles for receiving plant holders (14) having lower portions thereof submerged in water. The trays (10) are made from a polymeric composite material manufactured by heating 80 ml of distilled water to 80-90° C., adding 20 g of PVA while stirring, separately dissolving 12.5 g of chitosan in 50 ml of 1% lactic acid solution, separately prepare a slurry of 10 g of starch, dissolving 7.5 g of PVP in distilled water, to the PVA-chitosan mixture, the starch slurry and PVP solution were added, next 5 g of glycerol is added, ZnO nanoparticles (25 mg for a total volume of 100 ml) were pre-dispersed in a glycerol or water (5-10 ml) and added to the mixture and the volume adjusted to 100 ml using distilled water.

### FIELD OF INVENTION

This invention relates to a method of manufacturing a biodegradable polymeric nutrient releasing material. The invention relates further to articles and containers made therefrom, particularly containers for containing plants.

### BACKGROUND TO INVENTION

The rapid growth of urbanization, population, and industrialization has placed immense pressure on traditional agricultural systems, particularly in areas facing limited arable land, water scarcity, and environmental degradation.

To combat these challenges, alternative farming practices such as hydroponics have gained significant attention due to their ability to grow plants without soil, offering efficient resource use, including water and space. However, one of the key challenges in hydroponic systems is the efficient and sustainable delivery of essential nutrients to plants.

Traditional methods of nutrient delivery often require regular monitoring and replenishment, which not only adds to operational costs but also risks over-fertilization, leading to nutrient wastage and environmental harm.

In hydroponics, nutrient management is critical for plant growth, particularly for essential micronutrients such as zinc (Zn). Zinc plays a vital role in plant metabolic processes, including enzyme activation, protein synthesis, and overall growth. A deficiency in zinc can severely affect plant health, leading to stunted growth, poor root development, and reduced crop yield. Traditionally, zinc and other micronutrients are provided in nutrient solutions that need to be replenished frequently. However, the uncontrolled release of these nutrients often leads to inefficiencies and nutrient loss.

To address these challenges, recent advancements in nanotechnology have opened up new avenues for controlled nutrient delivery in agricultural systems.

ZnO nanoparticles have shown great promise in agriculture due to their ability to enhance the bioavailability of nutrients while enabling a sustained release of ions over time.

Studies have demonstrated that ZnO nanoparticles can be used to increase nutrient uptake, improve plant growth, and reduce nutrient loss by providing controlled release, making them an ideal candidate for enhancing hydroponic systems.

Another disadvantage of current technology is that hydroponic containers are generally constructed from non-biodegradable materials, which are disadvantageous to the environment.

A need exists for eco-friendly and efficient systems that combine nanoparticles with biodegradable materials for long-term nutrient release in hydroponic applications.

### SUMMARY OF INVENTION

According to a first aspect of the invention there is provided a nutrient releasing material comprising:
a biodegradable polymer composite including:
a blend of polyvinyl alcohol, chitosan, starch, polyvinylpyrrolidone, glycerol, and nanoparticles for promoting plant growth.

The nanoparticles may comprise one or more elements selected from the group comprising: macronutrients and micronutrients. More particularly, the macronutrients may include one or more of the following elements: N, P, K, Ca, Mg, S. The micronutrients may include one or more of the following elements: Fe, Cu, Mn, Mo, B, and Zn. In a particular embodiment, the nanoparticles may be in the form of ZnO nanoparticles. In another embodiment, the nanoparticles may include copper or iron.

The biodegradable polymer may be operable for releasing nanoparticles, for example, zinc, copper, or iron ions in a controlled manner.

More specifically, the biodegradable polymer may further be operable for releasing ions on a continuous basis. As such, the biodegradable polymer may be operable to provide for a low-maintenance method of plant care.

The polyvinyl alcohol, chitosan, starch, and polyvinylpyrrolidone may define a matrix within which the nanoparticles are distributed. The nanoparticles may be uniformly distributed throughout the matrix.

According to a second aspect of the invention there is provided a method of manufacturing a material for nutrient release, the method comprising:
preparing a blend of Polyvinyl Alcohol, chitosan, starch, polyvinylpyrrolidone, glycerol, and nanoparticles; and
curing the blend.

The blend may be cured at 40° C. More specifically, the blend may be cured over a period of approximately 12 hours.

The nanoparticles may be in the form of zinc oxide (ZnO) nanoparticles. The nanoparticles, may alternatively, or additionally be in the form of copper or iron.

More particularly, the blend may be prepared according to the following method:
dissolving a predetermined quantity of Polyvinyl Alcohol in a predetermined quantity of a first solvent;
dissolving a predetermined quantity of chitosan in a predetermined quantity of a second solvent;
forming a slurry of a predetermined quantity of a third solvent and a predetermined quantity of starch;
dissolving a predetermined quantity of polyvinylpyrrolidone in a predetermined quantity of a fourth solvent;
disbursing a predetermined quantity of nanoparticles in a predetermined quantity of a fifth solvent;
forming a mixture of the dissolved polyvinylpyrrolidone and dissolved chitosan;
sequentially adding the slurry to the mixture while stirring to achieve a homogeneous blend;
adding a predetermined quantity of glycerol to the homogeneous blend and thoroughly distributing the glycerol thought the homogeneous blend;
disbursing a predetermined quantity of nanoparticles in a predetermined quantity of a fifth solvent;
adding the nanoparticle dispersion to homogeneous blend;
adjusting the total volume of the homogeneous blend to a predetermined volume by adding a sixth solvent.
stirring the homogeneous blend to achieve homogeneity.

In the case where the total volume is adjusted to 100 ml, the predetermined quantity of Polyvinyl Alcohol may be between 20 g to 25 g.

In the case where the total volume is adjusted to 100 ml, the predetermined quantity of the first solvent may be about 80 ml.

In the case where the total volume is adjusted to 100 ml, the predetermined quantity of chitosan may be between 12.5 g to 15 g.

In the case where the total volume is adjusted to 100 ml, the predetermined quantity of the second solvent may be about 50 ml.

In the case where the total volume is adjusted to 100 ml, the predetermined quantity of the starch may be about 10 g.

In the case where the total volume is adjusted to 100 ml, the predetermined quantity of the third solvent may be about 10 g.

In the case where the total volume is adjusted to 100 ml, the predetermined quantity of polyvinylpyrrolidone may be about 7.5 g to 10 g.

In the case where the total volume is adjusted to 100 ml, the predetermined quantity of the fourth solvent may be about 10 ml.

In the case where the total volume is adjusted to 100 ml, the predetermined quantity of glycerol may be about 5 g.

In the case where the total volume is adjusted to 100 ml, the predetermined quantity of nanoparticles may be about 25 mg.

In the case where the total volume is adjusted to 100 ml, the predetermined quantity of the fifth solvent may be about 5-10 ml.

In a preferred embodiment, in the case where the total volume is adjusted to 100 ml, the predetermined quantity of Polyvinyl Alcohol may be about 20 g.

In a preferred embodiment, in the case where the total volume is adjusted to 100 ml, the predetermined quantity of the first solvent may be about 80 ml.

In a preferred embodiment, in the case where the total volume is adjusted to 100 ml, the predetermined quantity of chitosan may be about 12.5 g.

In a preferred embodiment, in the case where the total volume is adjusted to 100 ml, the predetermined quantity of the second solvent may be about 50 ml.

In a preferred embodiment, in the case where the total volume is adjusted to 100 ml, the predetermined quantity of the starch may be about 10 g.

In a preferred embodiment, in the case where the total volume is adjusted to 100 ml, the predetermined quantity of the third solvent may be about 10 g.

In a preferred embodiment, in the case where the total volume is adjusted to 100 ml, the predetermined quantity of polyvinylpyrrolidone may be about 7.5 g.

In a preferred embodiment, in the case where the total volume is adjusted to 100 ml, the predetermined quantity of the fourth solvent may be about 10 ml.

In a preferred embodiment, in the case where the total volume is adjusted to 100 ml, the predetermined quantity of glycerol may be about 5 g.

In a preferred embodiment, in the case where the total volume is adjusted to 100 ml, the predetermined quantity of nanoparticles may be about 25 mg.

In a preferred embodiment, in the case where the total volume is adjusted to 100 ml, the predetermined quantity of the fifth solvent may be about 5-10 ml.

The first solvent may be heated to about 80-90° C.

The second solvent may be about 1% lactic acid solution.

The third solvent may be water.

The fourth solvent may be water.

The fifth solvent may be glycerol or water.

The water may be distilled water.

The invention may extend to articles made from the method of manufacturing a material for nutrient release, as defined and described hereinabove in accordance with the second aspect of the invention.

According to a third aspect of the invention, there is provided a container for containing plants, the container being constructed from the nutrient releasing material, in accordance of the first aspect of the invention.

The container may be manufactured by a method of manufacturing a material for nutrient release, in accordance with the second aspect of the invention.

The container may more specifically be in the form of a hydroponic container for containing plants grown hydroponically.

The container may be configured for optimum nutrient delivery thereby minimizing nutrient waste and over-fertilization.

The container may be formed in accordance with the method described and defined in accordance with the second aspect of the invention.

### BRIEF DESCRIPTION OF DRAWINGS

Further features of the invention are described hereinafter by way of a non-limiting example of the invention, with reference to and as illustrated in the accompanying schematic drawings. In the drawings:

FIG. 1 shows a scanning electron microscopy image and energy dispersive X-ray spectra of (a) control, (b) nanocomposite films in the form of a biodegradable polymeric nutrient releasing material in accordance with a first aspect of the invention;

FIG. 2 shows a graphic representation of FTIR-ATR spectra of (a) Control, (b) ZnO NP loaded composite films in the form of a biodegradable polymeric nutrient releasing material, in accordance with a first aspect of the invention, analysing the organic and inorganic components of the developed polymer composite films;

FIG. 3 shows a graphic comparison between the hydrodynamic properties of the polymer films, net moisture content, and water absorbance of a control and of the ZnO NP loaded nanocomposite film of FIG. 2;

FIG. 4 shows a graph showing (a) thermogravimetric analysis and (b) Derivative plot of the thermogravimetric analysis of (a) control and nanocomposite films of FIG. 2;

FIG. 5. a graph showing Zn mineral release profile from control and the ZnO-loaded nanocomposite films of FIG. 2 over 12 days;

FIG. 6 shows a graph demonstrating the percentage of germination of sweet pea seeds across the three treatments over a 72-hour period;

FIG. 7 shows a schematic graphic representation and illustration of fabrication of biodegradable polymeric composite with incorporated mineral nanoparticles, in accordance with the first aspect of the invention, and containers in accordance with the third aspect of the invention, for sustained mineral release for enhanced plant growth. FIG. 7 further shows a graph showing release of mineral ions over time.

### DETAILED DESCRIPTION OF THE DRAWINGS

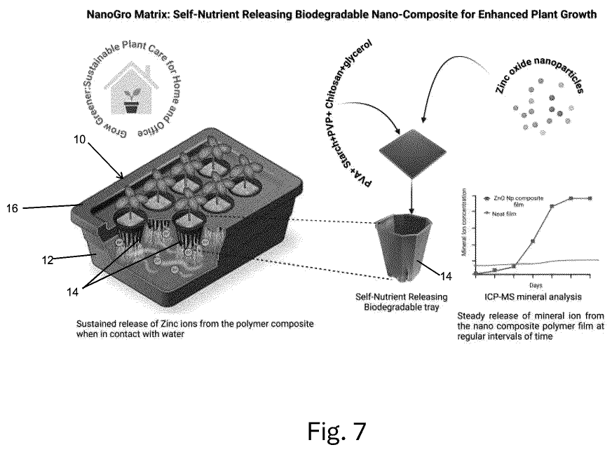

With reference to FIG. 7 of the drawings, a container in accordance with the third aspect of the invention, in the form of a tray for containing plants, is indicated generally by reference numeral 10.

The tray 10 is constructed from nutrient releasing material, in accordance of the first aspect of the invention. More particularly, the tray 10 is further manufactured by a method of manufacturing a material for nutrient release, in accordance with the second aspect of the invention.

As shown in FIG. 7, the tray 10 comprises a master tray 12 and a plurality of plant holders 14. The master tray 12 comprises a water container 14 and a cover element 16 for covering an upper open end of the water container 14. In use, the water container 14 is filled with water and the cover element 16 is fitted to close the open upper end of the water container 14.

The cover element 16 defines a number of spaced receptacles, within which the plant holder 14 can be located in a snug sliding fit.

When the plant holders 14 of fitted into the associated receptacles, the lower portions of the plant holders 14 are located below the water line of the water in the master tray 12, such that plant holder 14 are partially submerged in the water.

As explained above, the master tray 12 and the plant holders 14 are composed of a nutrient releasing material, in accordance of the first aspect of the invention, as will be explained in more detail below.

The materials and methods of manufacturing the material for nutrient release is described herein below, with reference to manufacture of a polymeric composite film, however, it will be understood that the same procedure applies to manufacture of the tray 10, including the master tray 12, holders 14 and cover element 16.

A polymeric composite film was prepared by blending Polyvinyl Alcohol (PVA), chitosan, starch, polyvinylpyrrolidone (PVP), glycerol, and zinc oxide (ZnO) nanoparticles.

The procedure was carried out as follows:

First, 80 ml of distilled water was measured and heated to approximately 80-90° C. on a hot plate.

To this heated water, 20 g of PVA was gradually added while stirring continuously.

The mixture was stirred until the PVA was completely dissolved, resulting in a clear solution.

In a separate beaker, 12.5 g of chitosan was dissolved in 50 ml of 1% lactic acid solution, stirring until the chitosan was fully dissolved.

In another beaker, a slurry was prepared by adding 10 g of starch to a small amount of cold distilled water (approximately 10 ml), stirring to ensure the starch was uniformly dispersed.

Additionally, 7.5 g of PVP was dissolved in 10 ml of warm distilled water, ensuring complete dissolution of PVP in the solution.

To the PVA-chitosan mixture, the prepared starch slurry and PVP solution were added sequentially while stirring to achieve a homogeneous blend.

Next, 5 g of glycerol was added to the mixture to act as a plasticizer, ensuring thorough distribution throughout the solution.

ZnO nanoparticles (25 mg for a total volume of 100 ml) were pre-dispersed in a small amount of glycerol or water (5-10 ml) to prevent clumping.

The nanoparticle dispersion was then slowly added to the polymeric mixture, ensuring even distribution of ZnO within the composite.

Finally, the total volume of the composite mixture was adjusted to 100 ml by gradually adding distilled water while maintaining continuous stirring.

The final mixture was stirred thoroughly using a mechanical or magnetic stirrer to ensure complete homogeneity.

The composite mixture was then poured onto a clean glass plate and left to cure at 40° C. overnight.

A control film was fabricated in a similar manner without the addition of ZnO nanoparticles to compare the effects of nanoparticle incorporation on the composite properties.

It will be understood that in order to manufacture the trays 10, a sufficient volume of the composite mixture described and defined hereinabove, can be poured into specially manufactured molds and left to cure in order to form the tray 10.

More particularly, the molds include separate molds purposefully constructed to form the master tray 12, plurality of plant holders 14 and cover element 16, when the composite mixture is poured into the respective mold and cured.

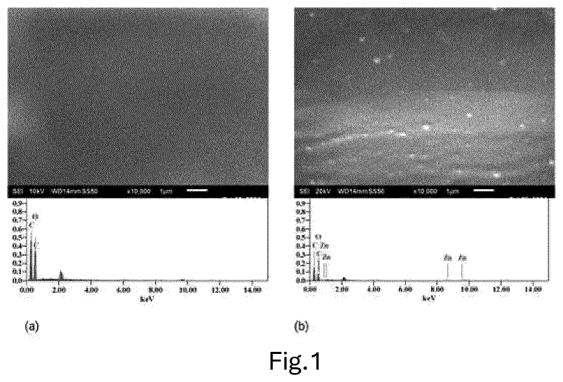

Features, properties and characteristics of the nanocomposite film described hereinabove will be explained with reference to FIGS. 1 to 5 of the drawings. These same properties, features and characteristics naturally apply equally to the material of the trays 10 including the material of the master tray 12, plurality of plant holders 14 and cover element 16.

Referring to FIG. 1, FIG. 1 shows a scanning electron microscopy image and Energy dispersive X-ray spectra of (a) control, (b) nanocomposite films.

The SEM images and EDX spectra shown in FIG. 1 illustrate the morphological and elemental differences between the control and ZnO nanoparticle-loaded composite films.

The control film (FIG. 1a) exhibits a smooth and homogeneous surface, indicating a well-mixed polymeric matrix composed of PVA, starch, PVP, glycerol, and chitosan.

The corresponding EDX spectrum displays peaks for carbon (C) and oxygen (O), consistent with the primary polymer constituents and confirming the absence of ZnO nanoparticles.

In contrast, the ZnO-loaded composite film (FIG. 1b) shows a more uneven surface morphology, indicating the successful integration and distribution of ZnO nanoparticles within the polymer matrix.

The EDX spectrum for this sample confirms the presence of zinc (Zn) peaks, alongside carbon and oxygen, verifying the incorporation of ZnO into the composite.

The observed changes in surface morphology and elemental composition suggest potential modifications in the material properties, such as enhanced mechanical strength, thermal stability, or antimicrobial behavior, due to the addition of ZnO.

This indicates effective interaction and distribution of ZnO within the polymer matrix, distinguishing the nanocomposite from the control.

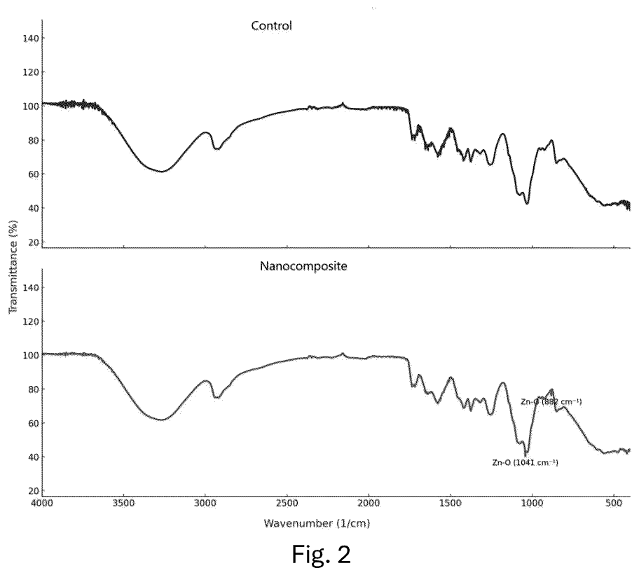

Referring to FIG. 2. FIG. 2 shows FTIR-ATR spectra of (a) Control, (b) ZnO NP loaded composite films analyzing the organic and inorganic components of the developed polymer composite films.

The FTIR spectra shown in FIG. 2 display characteristic peaks for the control sample, including a broad O—H stretching band around 3200-3500 cm⁻¹, indicative of strong hydrogen bonding among PVA, starch, and chitosan, along with C—H stretching near 2900 cm⁻¹ and a C═O stretching peak at 1650 cm⁻¹, associated with PVP and glycerol.

Peaks in the 1000-1200 cm⁻¹ range reflect C—O—C and C—O stretching, representing the backbone structure of starch, PVA, and chitosan.

In the nanocomposite, the incorporation of ZnO nanoparticles is confirmed by new peaks at 688 cm⁻¹ and 1041 cm⁻¹, corresponding to Zn—O vibrations.

Shifts and variations in the O—H stretching region suggest interactions between ZnO and hydroxyl groups, modifying the hydrogen bonding network.

These spectral changes indicate strong interactions between ZnO and the polymer matrix, potentially enhancing the structural and mechanical properties compared to the control.

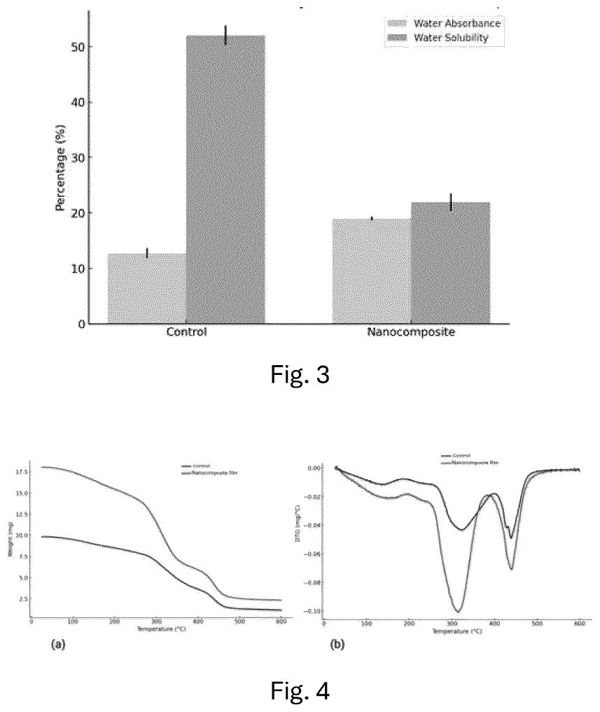

Referring to FIG. 3 FIG. 3 shows a comparison between the hydrodynamic properties of the polymer films, net moisture content, and water absorbance of control and ZnO NP loaded nanocomposite film.

In FIG. 3, a distinct difference in the water absorbance and water solubility between the control and the nanocomposite films is observed.

The nanocomposite film, which incorporates ZnO nanoparticles within a biodegradable polymer matrix, exhibited a higher water absorbance (18.99%±0.32) compared to the control film (12.73%±0.94).

This increase in water absorbance may be attributed to the hydrophilic nature of the polymer matrix combined with the nanoparticles, allowing for more water interaction at the surface.

Conversely, the water solubility of the nanocomposite film was significantly lower (21.94%±1.55) compared to the control film (52.06%±1.73).

This reduction suggests improved water resistance and stability due to the uniform dispersion of ZnO nanoparticles, as confirmed by FTIR and SEM analyses.

The ZnO nanoparticles likely enhanced the cross-linking within the polymer matrix, reducing its solubility and making it more resilient to water exposure.

Referring to FIG. 4. FIG. 4 shows (a) Thermogravimetric analysis and (b) Derivative plot of the thermogravimetric analysis of (a) control and nanocomposite films.

The TGA (Thermogravimetric Analysis) and DTG (Derivative Thermogravimetric Analysis) results (FIG. 4) illustrate significant differences in the thermal behavior between the control sample (comprising PVA, PVP, potato starch, and chitosan) and the ZnO-loaded composite.

In the TGA analysis, both samples display an initial weight loss around 100-150° C. due to moisture evaporation.

The control sample undergoes major decomposition between 250-350° C., attributed to the breakdown of PVA and PVP polymers, with further degradation of starch and chitosan occurring at 400-500° C., leaving minimal residual mass beyond 500° C.

In contrast, the ZnO-loaded composite demonstrates enhanced thermal stability, with polymer decomposition peaks shifting to higher temperatures, indicating delayed degradation due to the stabilizing effect of ZnO nanoparticles.

The composite also retains more residual mass above 500° C., reflecting the non-decomposable nature of ZnO.

The DTG analysis corroborates these findings, showing sharper peaks for the control sample within the 250-350° C. and 400-500° C. ranges, signifying rapid polymer and biopolymer degradation.

Conversely, the ZnO-loaded composite exhibits broader, less intense peaks over a wider temperature range (280-360° C.), indicating slower, more gradual decomposition and improved heat resistance.

The presence of ZnO reinforces the polymer matrix, enhancing its thermal stability and suggesting potential suitability for high-temperature applications compared to the control material.

TABLE 1
Mechanical Properties of the Control Film
and ZnO-Loaded Nanocomposite Film

| | Tensile | Elongation | Young's |
|---|---|---|---|
| | Strength | at Break | Modulus |
| | (MPa) | (%) | (MPa) |
| Control | 10.56 (±0.68) | 33.68 (±1.58) | 31.1 (±0.32) |
| Nanocomposite | 8.77 (±0.45) | 31.63 (±1.6) | 27.73 (±0.02) |
| film | | | |

The mechanical properties of the control film exhibited a tensile strength of 10.56 MPa±0.68, while the nanocomposite film showed a slightly lower tensile strength of 8.77 MPa±0.45.

This decrease in tensile strength in the nanocomposite film could be attributed to the incorporation of ZnO nanoparticles, which may have slightly altered the polymer matrix structure, resulting in reduced cohesive strength.

In terms of elongation at break, the control film displayed a value of 33.68%±1.58, compared to 31.63%±1.60 for the nanocomposite film.

The marginal decrease in elongation at break indicates that the nanocomposite film retains flexibility but may be slightly less elastic than the control film due to the stiffening effect of ZnO nanoparticles.

The Young's modulus of the control film was measured at 31.1 MPa±0.32, while the nanocomposite film showed a reduced value of 27.73 MPa±0.02.

This decrease in Young's modulus suggests that the incorporation of ZnO nanoparticles leads to a more flexible and less rigid material, which could be beneficial for applications requiring enhanced pliability.

Overall, while the incorporation of ZnO nanoparticles slightly reduces tensile strength and elasticity, it provides improved flexibility, potentially enhancing the nanocomposite's adaptability in various applications.

The balance between mechanical strength and flexibility is a key characteristic that can be tailored based on specific application requirements.

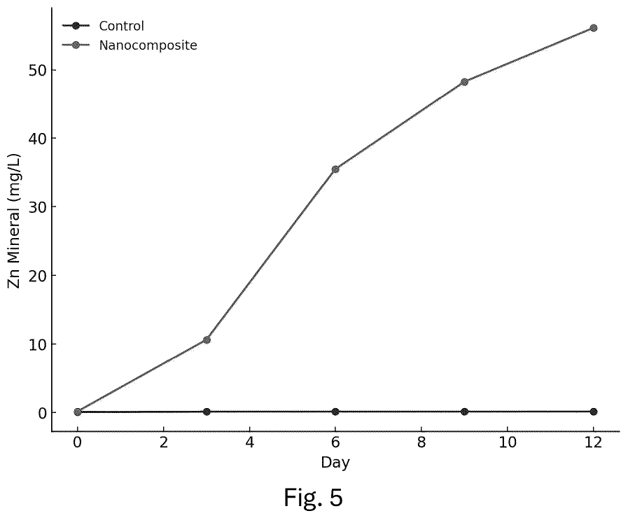

Referring to FIG. 5. FIG. 5 shows Zn mineral release profile from control and ZnO-loaded nanocomposite films over 12 days.

FIG. 5 illustrates the Zn mineral release profile from the control and ZnO-loaded nanocomposite films over a 12-day period.

The control film showed minimal Zn release, with values starting at 0.078 mg/L and gradually increasing to 0.155 mg/L by day 12.

In contrast, the nanocomposite film exhibited a significantly higher Zn release, beginning at 0.163 mg/L on day 0 and reaching 56.091 mg/L by day 12.

The rapid initial release observed in the nanocomposite film can be attributed to the surface-exposed ZnO nanoparticles, leading to an accelerated ion release within the first few days.

This was followed by a more gradual and sustained release, indicating controlled diffusion of Zn ions through the polymer matrix.

This controlled nutrient delivery system reduces the need for frequent supplementation, enhancing efficiency for hydroponic and plant growth applications.

The consistent and sustained release of Zn ions from the nanocomposite highlights its potential to provide long-term plant nutrition, minimizing environmental impact and supporting optimal growth conditions.

### Seed Germination

An experiment was designed to assess the effect of self-nutrient releasing film with ZnO nanoparticles on the germination of sweet pea seeds compared to conventional methods using tissue paper (wet) and film control.

Sweet pea seeds were placed on three different substrates:
the control consisting of tissue paper moistened with water,
the film control made from a biodegradable polymeric film without nanoparticles,
the nanocomposite film (Film+NP), which incorporated ZnO nanoparticles (25 mg for 100 mL).

The seeds were placed on each treatment for 24 hours, 48 hours, and 72 hours, with the percentage of germination recorded at each time point.

Germination was assessed by counting the number of seeds that sprouted.

The experiment was performed in triplicate to ensure reliability of the results.

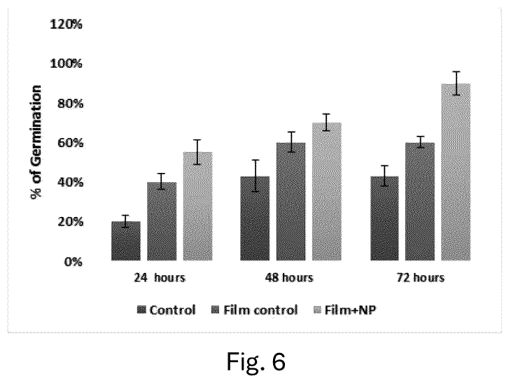

Referring to FIG. 6. The data, as shown in FIG. 6, demonstrates the percentage of germination of sweet pea seeds across the three treatments over a 72-hour period.

The control (wet tissue paper) exhibited a gradual increase in germination, reaching approximately 80% by 72 hours.

The film control, made from biodegradable polymeric film without nanoparticles, showed a slightly higher germination rate than the control at all time points, with a significant improvement by 72 hours.

However, the most remarkable improvement in germination was observed in the Film+NP group, where the germination rate reached 100% by 72 hours.

This enhanced germination in the Film+NP group is likely due to the ZnO nanoparticles embedded in the polymer matrix, which provided a sustained release of zinc ions.

Zinc is crucial for various enzymatic and metabolic processes during seed germination, thus promoting faster and healthier growth.

The nanoparticles likely contributed to not only the structural support of the seeds but also the controlled release of zinc, which accelerated the germination process.

In conclusion, the results from FIG. 7 clearly show that the Film+NP treatment significantly outperforms both the film control and control, demonstrating the effectiveness of ZnO nanoparticles in enhancing seed germination.

This innovative approach to seed priming through nanoparticle-enriched films presents a promising strategy for improving germination rates, particularly in hydroponic systems and controlled environment agriculture.

### Discussion and Conclusions

The polymer matrix exhibits improved mechanical and thermal stability, as demonstrated by comprehensive mechanical characterization, including tensile strength testing, thermogravimetric analysis (TGA), and enhanced water resistance with low solubility and degradation rates.

FTIR and SEM analyses confirm a uniform distribution of nanoparticles throughout the matrix, supporting the material's durability and performance.

Furthermore, ICP-MS studies highlight a steady, sustained release of zinc ions, ensuring consistent nutrient availability for plant growth.

The material's unique composition also reduces water solubility, securely encapsulating the ZnO nanoparticles to avoid leaching, providing a reliable and eco-friendly hydroponic solution.

In seed germination studies conducted with sweet pea seeds, the material significantly enhanced germination rates, with the nanocomposite (ZnO nanoparticle-infused film) demonstrating 100% germination within 72 hours, compared to 80% in the control setup.

These results indicate the material's effectiveness in promoting plant growth, with potential applications in sustainable agriculture and hydroponics.

This innovation not only promotes sustainable, convenient plant care but also opens the door for future research to incorporate additional nutrient nanoparticles, offering expanded nutrient support for diverse plant species and growth conditions.

### Advantages Over Traditional Hydroponic Solutions:

Sustained Nutrient Release: Unlike traditional systems that require frequent nutrient adjustments, the self-nutrient releasing material provides a continuous, controlled release of zinc ions, reducing the need for regular replenishment and making the system more autonomous.

Reduced Nutrient Waste: The material ensures optimized nutrient delivery, minimizing nutrient wastage and preventing over-fertilization, which is common in traditional hydroponics.

Improved Resource Efficiency: By reducing the need for frequent nutrient inputs, this material enhances resource efficiency, making the system more cost-effective over time.

Environmental Sustainability: Being biodegradable, the material minimizes the environmental impact compared to traditional hydroponic systems that rely on synthetic fertilizers and chemical runoff.

Reduced Labor: The automated nutrient release minimizes the need for constant monitoring and adjustments, reducing labor and maintenance requirements.

Consistent Nutrient Availability: Unlike fluctuating nutrient levels in traditional systems, the material ensures consistent nutrient delivery, promoting healthier plant growth and higher yields.

Customization: This material can be tailored to release specific nutrients like zinc, copper, or iron, offering precise nutrient management for various plant species.

Long-Term Use: Unlike traditional solutions that need regular changes, this material offers a long-lasting solution for nutrient delivery, reducing maintenance costs.

In essence, this material provides a more efficient, sustainable, and cost-effective solution for hydroponic systems, improving nutrient management, plant health, and environmental impact.

Moreover, the integration of biodegradable polymer matrices such as PVA (Polyvinyl Alcohol), chitosan, starch, and PVP allows for the creation of materials that are not only effective in releasing nutrients but also environmentally friendly.

These polymers are derived from renewable sources and, when combined with nanoparticles, offer enhanced performance in terms of mechanical strength, flexibility, and biodegradability.

This aligns with the increasing demand for eco-friendly agricultural solutions that minimize the impact on the environment.

This self-nutrient releasing composite material represents a major breakthrough in hydroponic systems by embedding ZnO nanoparticles within a biodegradable polymer matrix, enabling the sustainable, controlled release of zinc ions.

Previous research on nanoparticle-based nutrient delivery systems has shown potential for improving plant growth; however, none have effectively combined nanoparticles with biodegradable polymer matrices to achieve the sustained release of zinc in a hydroponic system.

This unique combination addresses several challenges in modern agriculture: reducing the reliance on traditional fertilization methods, promoting the efficient use of resources, and supporting sustainable and eco-friendly plant cultivation.

As the demand for sustainable agricultural practices continues to rise, the ability to efficiently manage and deliver nutrients in a controlled manner is key to enhancing the productivity and sustainability of future farming systems.

This technology not only enhances the functionality of hydroponic systems but also contributes significantly to the broader goals of sustainable agriculture and food security.

### Unique Aspects of this Invention

This invention introduces a novel polymeric composite material designed for hydroponic systems that uniquely combines biodegradable polymers with ZnO nanoparticles to provide a sustained and controlled release of nutrients, specifically zinc ions, for plant growth.

Advantages and characterizing features of the invention include the following key features:

### Nanoparticle-Enhanced Nutrient Delivery:

The integration of ZnO nanoparticles within a biodegradable polymer matrix is a novel approach for sustained nutrient release in hydroponic systems.

Traditional nutrient solutions rely on constant replenishment, which can be labor-intensive and wasteful.

This invention uniquely uses nanotechnology to release zinc ions gradually, providing a continuous source of essential micronutrients to plants.

This combination of nanotechnology with biodegradable polymers is not found in conventional hydroponic materials.

### Customizability for Various Nutrient Needs:

The material can be tailored to release a variety of nutrient ions (such as zinc, copper, magnesium, and iron) by incorporating different nanoparticles.

This feature allows it to cater to specific plant nutrient requirements, making it far more versatile and customizable than traditional hydroponic solutions, which typically rely on a fixed mix of nutrients.

This adaptability makes it novel in providing precision nutrient delivery that is specific to different plant species.

### Biodegradability and Sustainability:

Unlike traditional hydroponic systems that often rely on synthetic, non-biodegradable materials or require continuous external nutrient solutions, the polymer matrix in this invention is made from biodegradable polymers like PVA, chitosan, starch, and PVP, making it environmentally friendly.

This reduces waste and aligns with modern sustainability goals in agriculture, making the material not only effective but also eco-friendly-another aspect not commonly found in existing hydroponic solutions.

### Controlled Release Without External Monitoring:

The self-regulating nutrient release capability of the material ensures that plants receive a steady supply of zinc without the need for frequent manual adjustments to the nutrient solution.

This is a unique feature that significantly reduces the time, labor, and expertise needed for managing hydroponic systems.

Traditional systems often require constant monitoring and manual nutrient management, whereas this invention offers an automated, long-term nutrient delivery system.

### Improved Plant Growth and Health:

The gradual and controlled release of zinc ions, a crucial micronutrient, directly impacts plant growth, enzyme activation, and overall health.

By embedding these nanoparticles in a polymeric matrix, the material ensures the nutrients are available over an extended period, which traditional solutions often fail to do, where nutrient levels fluctuate and can result in deficiencies or nutrient imbalances.

In conclusion, this invention is novel, non-obvious, and inventive, offering a unique, sustainable solution to nutrient delivery in hydroponic systems, which distinguishes it from existing technologies and makes it suitable for patent protection.

### Benefits:

### Efficient and Sustainable Nutrient Delivery:

The sustained release of zinc ions ensures that plants receive a continuous supply of nutrients without the need for frequent replenishment, resulting in reduced labor and time-saving for growers.

This system is more efficient than traditional nutrient solutions, reducing the need for constant monitoring and adjustments.

### Cost-Effective:

By reducing the frequency of nutrient replacement and eliminating the need for costly fertilizers, this material offers a cost-effective solution in the long run.

The self-regulating nutrient release minimizes operational costs associated with nutrient management in hydroponic systems.

### Environmental Sustainability:

The use of biodegradable polymers ensures the material is eco-friendly and reduces environmental waste.

This aligns with the growing demand for sustainable agricultural solutions, minimizing the environmental impact of traditional farming practices.

### Customizable and Versatile:

The ability to incorporate various nanoparticles for specific nutrient releases makes the material adaptable to different plant needs, enhancing its versatility.

It can be used for a wide range of crops, offering precise control over the delivery of essential nutrients.

### Easy Care:

With the self-regulating nutrient release system, this material makes plant care much easier.

Growers don't have to constantly monitor and adjust nutrient levels, simplifying the hydroponic process and reducing the amount of maintenance needed for optimal plant growth.

### Improved Plant Growth and Yield:

The controlled release of zinc and other nutrients ensures optimal plant growth, reducing the risk of nutrient deficiencies and promoting healthier plants.

This leads to higher yields and more robust crops in hydroponic systems.

### Reduced Dependency on External Inputs:

The material minimizes the need for external nutrient solutions, offering a self-sustaining nutrient delivery system that reduces reliance on chemical fertilizers, contributing to resource efficiency and sustainability.

In summary, this invention provides faster operation, lower production costs, environmental sustainability, and improved plant health-making it an innovative and beneficial solution for modern hydroponic farming.

### The Need for Innovation:

In light of these challenges, there is a growing demand for hydroponic solutions that streamline plant care while ensuring consistent nutrient delivery.

The development of self-nutrient releasing trays 10 addresses this need by offering a convenient and efficient method for plant cultivation.

By embedding nutrient-rich nanoparticles within a biodegradable polymer matrix, these trays 10 provide a sustainable and long-lasting source of essential nutrients for plants.

The controlled, sustained release of nutrients eliminates the need for frequent monitoring and manual intervention, allowing users to enjoy lush, healthy plants with minimal effort.

Furthermore, the biodegradable nature of the polymer matrix aligns with the increasing emphasis on environmental sustainability in agriculture.

By reducing reliance on soil-based systems and minimizing nutrient waste, self-nutrient releasing trays 10 contribute to more sustainable and eco-friendly plant cultivation practices.

In a hydroponic growth setup, trays 10 made from the self-nutrient releasing material were placed under controlled conditions with plants such as sweet pea.

The material provided a steady supply of zinc ions, promoting plant health and growth without the need for frequent nutrient solution changes.

The plants grown in trays 10 made from the nanocomposite material exhibited stronger growth and healthier roots compared to those grown with conventional hydroponic methods, demonstrating the material's effectiveness in enhancing plant development and reducing the need for constant nutrient adjustments.

### Advantages Over Current Technologies

### Sustained and Controlled Nutrient Release:

Unlike conventional hydroponic systems, which require frequent nutrient solution changes, this material provides continuous, controlled release of zinc ions.

This results in reduced labor, time-saving, and minimized resource usage by eliminating the need for regular monitoring and replenishment.

### Reduced Nutrient Waste:

The material ensures optimized nutrient delivery with minimal wastage.

Traditional hydroponic systems often suffer from excess nutrient application, which can lead to nutrient runoff and environmental pollution.

This invention's controlled release mechanism reduces such waste and ensures more efficient use of nutrients.

### Cost-Effective:

By reducing the need for frequent nutrient solutions and offering a long-term nutrient delivery system, this material significantly lowers operational costs, especially for large-scale hydroponic operations.

### Environmentally Friendly:

The use of biodegradable polymers makes the material eco-friendly, addressing the increasing demand for sustainable agricultural practices.

The biodegradable nature of the polymer reduces waste and pollution compared to synthetic materials used in traditional hydroponic systems.

### Customizable for Various Nutrients:

The ability to incorporate different nanoparticles allows for tailored nutrient delivery depending on the plant's needs, providing greater flexibility compared to traditional hydroponic solutions that often require generic nutrient mixtures.

### Improved Plant Growth:

The sustained release of zinc, an essential micronutrient, ensures optimal plant health, reduces the risk of deficiencies, and supports improved root development and overall growth, leading to higher yields and healthier plants.

### Ease of Use and Reduced Maintenance:

With self-regulating nutrient release, the material simplifies plant care by reducing the need for frequent adjustments, making it ideal for both commercial and home growers.

### Disadvantages or Limitations

### Cost of Production:

The initial cost of producing nanoparticle-incorporated biodegradable materials may be higher than traditional plastic trays.

The cost-effectiveness needs to be assessed for large-scale implementation.

### Nanoparticle Safety Concerns:

There might be concerns regarding the long-term effects of nanoparticles on human health and the environment.

Thorough safety evaluations and regulations are necessary.

### Degradation Rate Control:

Achieving the optimal degradation rate of the biodegradable polymer to match the nutrient release profile might be challenging.

Too fast or too slow degradation can affect the efficiency.

### Scalability:

Scaling up the production process to meet commercial demands while maintaining quality and consistency can be a significant challenge.

### Overcoming the Limitations

### Cost Reduction:

Research into cost-effective manufacturing processes and economies of scale can help reduce production costs.

Additionally, the use of locally sourced materials and advanced fabrication techniques can make the product more affordable.

### Safety Evaluations:

Conducting comprehensive studies on the environmental and health impacts of nanoparticles will help address safety concerns.

Developing standardized guidelines for the use of nanoparticles in agriculture can ensure their safe application.

### Optimized Formulation:

Fine-tuning the polymer composition and processing conditions can help control the degradation rate.

This may involve adjusting the ratios of PVA, starch, and glycerol or incorporating additives that modulate the breakdown process.

### Pilot Programs:

Implementing pilot programs to test the scalability and effectiveness of the trays 10 in real-world agricultural settings can provide valuable data.

This feedback can be used to refine the product before large-scale rollout.

By addressing these limitations and capitalizing on its advantages, the self-nutrient releasing tray 10 holds the potential to significantly advance sustainable agricultural practices and improve plant cultivation efficiency.

### Market Interest

### Hydroponic Farmers and Commercial Growers:

Hydroponic farming is a rapidly growing sector, with a projected market size of $16.5 billion by 2025.

The ability to reduce nutrient waste, lower operational costs, and minimize maintenance will appeal to both small-scale and large-scale commercial hydroponic farms.

With increasing consumer demand for locally grown, sustainable crops, hydroponic farmers are seeking innovative solutions that optimize resource use and reduce costs.

This invention offers a cost-effective, low-maintenance, and environmentally friendly solution that fits perfectly within the expanding hydroponics market.

### Urban and Vertical Farms:

Vertical farming is gaining traction in urban environments as a means of producing fresh food with minimal space and water.

The global vertical farming market is expected to reach $12.77 billion by 2026.

The self-nutrient releasing trays 10 can be used in vertical farming systems to improve plant growth by providing a continuous nutrient supply, reducing the need for frequent nutrient solution changes, and ensuring sustainable resource use.

This market is particularly interested in innovative and efficient technologies that support food security in urban areas.

### Agricultural Technology (AgTech) Companies:

AgTech companies, which focus on developing innovative technologies for agriculture, are increasingly investing in sustainable and efficient solutions for crop production.

The controlled-release feature of this material can appeal to AgTech innovators looking to integrate nanotechnology and biodegradable materials into their systems.

This invention provides a clear opportunity for AgTech firms to expand their portfolio with a product that supports sustainable agriculture.

### Home Gardening Enthusiasts:

With the rise in interest in home gardening and DIY hydroponics systems, the market for personal use of hydroponic systems is expanding.

The easy-care nature of this material, which minimizes the need for frequent nutrient changes, makes it highly attractive to hobbyist gardeners and home growers.

The increasing trend in sustainable living and home-grown food further increases the potential market for such products.

### Environmental and Sustainability-Oriented Organizations:

Organizations focused on environmental sustainability and eco-friendly solutions in agriculture may find this invention appealing due to its biodegradable nature and its potential to reduce fertilizer runoff.

This invention aligns with global goals of reducing agricultural waste and adopting sustainable farming practices.

As of 2021, the sustainable agriculture market is estimated to be worth $15.3 billion, and with increasing interest in reducing the environmental impact of farming, this material is well-positioned for adoption in eco-friendly agriculture initiatives.

### Research Institutions and Universities:

Academic and research institutions engaged in studies related to sustainable farming, hydroponics, and nanotechnology may have an interest in the technology.

This invention could serve as the foundation for further research into controlled nutrient release and its impact on plant growth and agricultural sustainability.

Universities and institutions focusing on innovative agricultural practices could see this as an opportunity to expand their research into nano-enabled agriculture.

### Government and NGOs Promoting Food Security:

Governments and NGOs focused on food security, especially in regions with limited access to arable land and water, may be interested in this technology.

Hydroponics is often viewed as a solution to address food shortages and resource scarcity, and the introduction of a sustainable nutrient delivery system will likely be attractive for policymakers and organizations promoting agricultural innovation in developing countries.

### Potential Market Size

The global hydroponics market is projected to grow from $16.5 billion in 2021 to $25.1 billion by 2027, with a CAGR of 8.6%.

The vertical farming market is expected to grow to $12.77 billion by 2026.

The AgTech market, which includes innovations in farming technologies, is valued at $22.5 billion in 2021 and is expected to expand significantly, with a focus on sustainable solutions.

These statistics suggest a substantial and expanding market for the self-nutrient releasing material in sectors that are actively seeking innovative and sustainable technologies to enhance agricultural productivity, reduce costs, and minimize environmental impact.

### CONCLUSION

This invention holds strong potential interest from a variety of sectors, including commercial hydroponic farms, urban farming, AgTech companies, home gardeners, and sustainability-focused organizations.

Its cost-effectiveness, ease of use, and sustainability make it an attractive option in a rapidly growing agricultural market, addressing both economic and environmental concerns.

### Unexpected Advantages

The inventors have unexpectedly found that incorporating PVP (Polyvinylpyrrolidone) and chitosan into the biodegradable polymer matrix resulted in significantly improved water resistance and film durability, which were critical for ensuring consistent nutrient release over time. through practical experimentation, it became clear that these materials greatly enhanced the water retention properties and structural integrity of the polymer matrix.

### 1. Unexpected Advantage to the Combination

The combination of PVA, chitosan, starch, PVP, and ZnO nanoparticles in the polymeric composite film results in several unexpected advantages, which were not anticipated based on prior research:

Enhanced Water Resistance: The inclusion of chitosan and PVP unexpectedly improves the water resistance of the material. Initially, PVA alone was known for its water solubility, but the addition of these two components minimizes degradation and ensures the material can withstand hydroponic environments.

Controlled Nutrient Release: The ZnO nanoparticles, integrated into this matrix, allow for the controlled release of zinc ions, an essential micronutrient for plants. The combination of PVA, chitosan, and PVP significantly enhances nanoparticle dispersion, reducing premature leaching and ensuring that nutrients are available over an extended period. This overcomes the common challenge of nutrient inefficiency and over-fertilization seen in traditional systems.

This combination provides a novel approach for sustained nutrient delivery in hydroponic systems, addressing issues like nutrient leaching and frequent replenishment, which are prevalent in conventional hydroponic materials.

### 2. Critical Components of the Polymer

The critical components of the polymer matrix that ensure the material's performance include:

PVA (Polyvinyl Alcohol): Provides the primary film-forming ability, mechanical strength, and biodegradability, serving as the base for nanoparticle integration.

Chitosan: Enhances water retention properties, increasing the resistance to degradation in moist conditions and promoting controlled nutrient release. It also contributes to biodegradability and provides antimicrobial properties.

PVP (Polyvinylpyrrolidone): Improves flexibility, helps with the dispersion of nanoparticles, and stabilizes the ZnO nanoparticles within the matrix, ensuring uniform distribution for consistent nutrient release.

ZnO nanoparticles: These are responsible for providing zinc ions essential for plant growth, particularly during germination and early development. Their integration into the polymer ensures sustained nutrient release over time.

### 3. Critical Quantities of the Constituents of the Polymer

The following quantities are important for achieving optimal performance:
PVA: 20 g per 100 mL. This provides a strong film structure and sufficient mechanical strength.
Chitosan: 12.5 g per 100 mL. This is necessary for water retention and biodegradability while ensuring the polymer matrix doesn't degrade prematurely in the hydroponic system.
PVP: 7.5 g per 100 mL. Contributes to flexibility and ensures proper dispersion of ZnO nanoparticles throughout the matrix.
ZnO nanoparticles: 25 mg per 100 mL. This concentration ensures a steady release of zinc ions, supporting plant growth without over-saturation or leaching.

### 4. Specific Parameters Important for the Criticality of the Combination and Unexpected Advantage

The key parameters for success include:
Proportions of PVA, PVP, and chitosan: The balance between these materials is crucial to provide film formation, flexibility, and water retention. These polymers must be combined in specific ratios to maintain stability and ensure optimal nutrient release.
ZnO nanoparticle dispersion: The size and uniformity of the nanoparticle dispersion are critical to ensure consistent nutrient release. Proper dispersion prevents clumping, which can compromise nutrient delivery.
Water retention: The composite must be capable of maintaining moisture for a sufficient time to sustain the nutrient release cycle, ensuring that plants receive consistent nutrition without needing frequent replenishment.
   5. The following aspects have been found to be important:
PVA: 20 g to 25 g per 100 mL for optimal strength and film formation.
Chitosan: 12.5 g to 15 g per 100 mL for improved water retention and biodegradability.
PVP: 7.5 g to 10 g per 100 mL for flexibility and dispersion of nanoparticles.
ZnO nanoparticles: 25 mg per 100 mL for consistent nutrient release without excessive leaching.

### 6. Range and Optimum Parameters

The optimum ranges are as follows:
PVA: 20 g-25 g per 100 mL
Chitosan: 12.5 g-15 g per 100 mL
PVP: 7.5 g-10 g per 100 mL
ZnO nanoparticles: 25 mg per 100 mL

These concentrations ensure superior water retention, mechanical stability, and efficient nutrient delivery.

7. Specific Interactions Between Polymer and Nanoparticles that Result in Unexpected Effects

The combination of PVA, PVP, chitosan, and ZnO nanoparticles results in:
Stabilization of the ZnO nanoparticles prevents clumping and ensures consistent release of zinc ions over time.
Improved nutrient availability: Chitosan enhances nutrient uptake by plants, while PVA protects the nanoparticles from premature degradation, resulting in long-lasting nutrient delivery.

### 8. Unexpected Synergistic Effect

The synergistic effect of combining PVA, PVP, chitosan, and ZnO nanoparticles results in:
Enhanced flexibility and water resistance ensure the material remains stable in moist hydroponic conditions while still delivering consistent nutrients.

Improved plant growth due to the controlled release of zinc is crucial for enzyme activation and overall plant health.

This combination of PVA, PVP, chitosan, and ZnO nanoparticles offers a novel and non-obvious solution to the challenges faced by traditional hydroponic materials. The unexpected advantages—particularly the enhanced water resistance and controlled nutrient release—distinguish this invention from known technologies.

This specification has been described with reference to embodiments of the invention. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of invention.

For example, the inventors have advantageously found that the nanoparticles need not necessarily include ZnO. The inventors have advantageable found that the nanoparticles may comprise one or more elements selected from the group comprising: macronutrients and micronutrients. More particularly, the macronutrients may include one or more of the following elements: N, P, K, Ca, Mg, S. The micronutrients may include one or more of the following elements: Fe, Cu, Mn, Mo, B, and Zn. The invention naturally extends to all such variations.

1. A nutrient releasing material consisting of:
a biodegradable polymer composite consisting of:
a blend of polyvinyl alcohol, chitosan, starch, polyvinylpyrrolidone, glycerol, and nanoparticles for promoting plant growth,
wherein the polyvinyl alcohol, chitosan, starch, and polyvinylpyrrolidone define a matrix within which the nanoparticles are uniformly distributed.

2. The material as claimed in claim 1, wherein the nanoparticles include one or more elements selected from the group comprising macronutrients and micronutrients.

3. The material as claimed in claim 2, wherein the nanoparticles are in the form of ZnO nanoparticles.

4. (canceled)

5. A method of manufacturing a material for nutrient release, the method consisting of:
preparing a homogeneous blend of Polyvinyl Alcohol, chitosan, starch, polyvinylpyrrolidone, glycerol, and nanoparticles; and
curing the homogeneous blend.

6. The method as claimed in claim 5, wherein the blend is cured at 40° C.

7. The method as claimed in claim 5, wherein, the blend is cured over a period of approximately 12 hours.

8. The method as claimed in claim 5, wherein the nanoparticles are in the form of zinc oxide (ZnO) nanoparticles.

9. The method as claimed in claim 5, wherein the blend is prepared according to the following method:
dissolving a predetermined quantity of Polyvinyl Alcohol in a predetermined quantity of a first solvent;
dissolving a predetermined quantity of chitosan in a predetermined quantity of a second solvent;
forming a slurry of a predetermined quantity of a third solvent and a predetermined quantity of starch;
dissolving a predetermined quantity of polyvinylpyrrolidone in a predetermined quantity of a fourth solvent;
disbursing a predetermined quantity of nanoparticles in a predetermined quantity of a fifth solvent;
forming a mixture of the dissolved polyvinylpyrrolidone and dissolved chitosan;
sequentially adding the slurry to the mixture while stirring to achieve a homogeneous blend;
adding a predetermined quantity of glycerol to the homogeneous blend and thoroughly distributing the glycerol thought the homogeneous blend;
adding the nanoparticle dispersion to homogeneous blend;
adjusting the total volume of the homogeneous blend to a predetermined volume by adding a sixth solvent; and
stirring the homogeneous blend to achieve homogeneity.

10. The method as claimed in claim 9, wherein, in the case where the total volume is adjusted to 100 ml, the predetermined quantities of the constituents are selected from one or more of the following quantities: the Polyvinyl Alcohol between 20 g to 25 g; the first solvent about 80 ml; the chitosan between 12.5 g to 15 g; the second solvent about 50 ml; the starch about 10 g; the third solvent about 10 g; the polyvinylpyrrolidone about 7.5 g to 10 g; the fourth solvent about 10 ml; the glycerol about 5 g; the nanoparticles about 25 mg; the fifth solvent about 5-10 ml.

11. The method as claimed in claim 9, wherein, in the case where the total volume is adjusted to 100 ml, the predetermined quantities of the constituents are selected from one or more of the following quantities: the Polyvinyl Alcohol about 20 g; the first solvent about 80 ml; the chitosan about 12.5 g the second solvent about 50 ml; the starch about 10 g; the third solvent about 10 g; the polyvinylpyrrolidone about 7.5 g; the fourth solvent about 10 ml; the glycerol about 5 g; the nanoparticles about 25 mg; the fifth solvent about 5-10 ml.

12. The method as claimed in claim 9, wherein, first solvent is heated to 80-90° C.

13. The method as claimed in claim 9, wherein, the second solvent is a 1% lactic acid solution.

14. The method as claimed in claim 9, wherein, the third solvent is water.

15. The method as claimed in claim 9, wherein, the fourth solvent is water.

16. The method as claimed in claim 9, wherein, the fifth solvent is glycerol or water.

17. The method as claimed in claim 9, wherein the water is distilled water.

18. Articles made from the material for nutrient release, as manufactured by the method as claimed in claim 9.

19. A container for containing plants, the container being constructed from the nutrient releasing material, as claimed in claim 1, and being in the form of a hydroponic container for containing plants grown hydroponically, the container being configured for optimum nutrient release and delivery.

20. A container manufactured by a method of manufacturing a material for nutrient release, as claimed in claim 5.

21. The nutrient releasing material as claimed in claim 1, wherein the quantities of constituents of the biodegradable polymer composite are as follows: polyvinyl alcohol: 20 g-25 g per 100 mL, Chitosan: 12.5 g-15 g per 100 mL, polyvinylpyrrolidone: 7.5 g-10 g per 100 mL, and ZnO nanoparticles: 25 mg per 100 mL.
